(19) United States
(12) Patent Application Publication
(10) Pub. No.: US 2004/0208626 A1
(43) Pub. Date: Oct. 21, 2004

(54) Coherent equalization of optical signals

(76) Inventors: Ken A. Nishimura, Fremont, CA (US); Brian E. Lemoff, Union City, CA (US); Charles D. Hoke, Menlo Park, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/202,553

(22) Filed: Jul. 23, 2002

(51) Int. Cl. H04B 10/08; H04B 10/00

(52) U.S. Cl. 398/161

(57) ABSTRACT

Coherent optical equalization is applied in the optical domain to an input optical signal that includes a wanted optical signal and an unwanted optical signal temporally delayed relative to the wanted optical signal. A first optical signal that includes at least the wanted optical signal is split into first beams that include a first beam subject to delay. The first beam subject to delay is delayed to provide a delayed first beam. Beams that include the delayed first beam are coherently summed to produce a second optical signal in which the unwanted optical signal has a reduced intensity compared with in the input optical signal. In the coherent summing, the instance of the wanted optical signal in the delayed first beam cancels the unwanted optical signal in another of the beams that are coherently summed.

### BACKGROUND OF THE INVENTION

Optical communication systems typically offer greater capacity or “bandwidth” than entirely electrically based communication systems. However, even current optical communication systems typically use electrical signals and light pulses to communicate information. In particular, the optical transmitter of such an optical communication system converts an electrical representing an information signal into an optical signal composed of pulses of light. The optical signal propagates to an optical receiver via an optical circuit. The optical receiver converts the optical signal back to an electrical signal that also represents the information signal.

A representative optical communication system 100 is depicted schematically in FIG. 1. Optical communication system 100 generally includes an electrical domain 102 and an optical domain 104. Electrical domain 102 includes optical transmitter 106 and optical receiver 108 linked by optical circuit 110. Optical transmitter 106 may include one or more laser diodes or other light-emitting devices, and optical receiver 108 may include one or more photodiodes or other light-detecting devices. Optical circuit 110 typically includes one or more optical fibers. Optical transmitter 106 generates an optical signal that propagates through optical circuit 110 to optical receiver 108.

Ideally, a light pulse propagated via optical circuit 110 has a square pulse shape, i.e., a plot against time of the intensity of the light pulse provided to optical receiver 108 by optical circuit 110 has a generally square shape. However, since the pulse width of a light pulse is typically small, e.g., 25-100 picoseconds, defects in either or both of transmitter 106 and optical circuit 110 typically result in the formation of light pulses having a non-ideal shape. For instance, a reflection in the optical circuit can generate from each light pulse constituting the optical signal an additional, unwanted light pulse. As a result, at least one unwanted optical signal propagates through the optical circuit in addition to the wanted optical signal that represents the information signal. Each unwanted optical signal has a waveform similar to that of the wanted optical signal but the waveform is temporally delayed relative to that of the wanted optical signal.

Thus, the optical receiver 108 receives not only the wanted optical that represents the information signal, but also at least one unwanted optical signal that is temporally delayed relative to the wanted optical signal. The unwanted optical signal(s) overlays the wanted optical signal at the receiver. As a result, optical receiver 108 generates an electrical signal that includes signal components contributed by the unwanted optical signals. Such an electrical signal can be problematic since it does not accurately represent the information signal: the electrical signal components contributed by the unwanted optical signals broaden the electrical pulses that correspond to the pulses of the wanted optical signal or may overlap subsequent ones of the pulses of the wanted optical signal. The broadened or overlapping pulses narrow the “eye” of the decoding of the information signal from the electrical signal. The unwanted optical signals therefore increase the bit error rate of the optical communication system 100, particularly as the bit rate is increased. In this regard, significant impairment of the bit error rate can occur where the light pulses of the unwanted optical signals broaden the light pulses of the wanted optical signal so significantly that adjacent pulses of the resulting combined optical signal overlap.

Methods performed in the electrical domain to compensate for defects in the optical circuit of an optical communication system are known. For example, it is known to pre-distort an electrical signal, i.e., to modify the shape of the electrical signal before converting the electrical signal to a light pulse, and to provide a corresponding pre-distorted light pulse to the optical circuit. As the pre-distorted light pulse propagates through the optical circuit, the physical properties of the optical circuit change the shape of the light pulse so that the light pulse provided to the optical receiver is closer to the ideal square shape.

Other methods performed in the electrical domain of compensating for defects in the optical circuit of an optical communication system also have been used. Typically, these methods include the use of electrical signal equalization in the optical receiver 108. The optical communication system 100 of FIG. 2 incorporates an electronic equalizer 202 that performs electrical signal equalization of the electrical signal generated by the optical receiver 108 in response to the optical signal. In such a system, the optical signal is converted to an electrical signal that is equalized by the electronic equalizer.

Prior-art optical communications have been bit rate limited due, in part, to the bandwidth limits of the incorporated electronic equalization systems. What is needed is an alternative form of equalization that enables higher communication rates to be used.

### SUMMARY OF THE INVENTION

The invention provides coherent optical equalizers and coherent optical equalization methods for performing coherent optical equalization in the optical domain of an input optical signal that includes a wanted optical signal and an unwanted optical signal temporally delayed relative to the wanted optical signal. In a coherent optical equalization method according to the invention, a first optical signal that includes at least the wanted optical signal is split into first beams that include a first beam subject to delay. The first beam subject to delay is delayed to provide a delayed first beam. Finally, beams that include the delayed first beam are coherently summed to produce a second optical signal in which the unwanted optical signal has a reduced intensity compared with in the input optical signal. In the coherent summing, the instance of the wanted optical signal in the delayed first beam cancels the unwanted optical signal in another of the beams that are coherently summed.

The coherent optical equalizer of the invention includes a beamsplitter, a delay component and a coherent summing component. The beamsplitter splits a first optical signal that includes at least the wanted optical signal into multiple first beams that include a first beam subject to delay. The delay component delays the first beam subject to delay to provide a delayed first beam. The coherent summing component receives beams including the delayed first beam and coherently sums the beams to provide a second optical signal in which the unwanted optical signal has a reduced intensity compared with in the input optical signal. Destructive interference in the coherent summing component between the instance of the wanted optical signal in the delayed first beam and the unwanted optical signal in another of the beams received by the coherent summing component cancels the unwanted optical signal.

To ensure that destructive interference occurs in the coherent summing, the relative delay between the delayed first beam and the other of the beams coherently summed is controlled to ensure the appropriate phase relationship between the delayed first beam and the other of the beams coherently summed. This phase relationship is in the range between 120° and 240°. The most effective elimination occurs with a phase difference of approximately 180°. Alternatively, relative phase control independent of the delay may be applied to provide the appropriate phase relationship.

Other systems, methods, features, and advantages of the invention will be or become apparent to one with skill in the art upon examination of the following drawings and detailed description. It is intended that all such additional systems, methods, features, and advantages be included within this description, be within the scope of the invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the invention. Moreover, in the drawings, like reference numerals designate corresponding parts throughout the several views.

FIG. 1 is a schematic diagram of a representative optical communication system of the prior art.

FIG. 2 is a schematic diagram of an embodiment of the optical communication system of FIG. 1 that includes an electronic equalizer.

FIG. 3 is a schematic diagram depicting an embodiment of an optical communication system incorporating a coherent optical equalizer of the invention.

FIG. 4A is a flowchart depicting a first embodiment of an coherent optical equalization method of the invention.

FIG. 4B is a flowchart depicting a practical embodiment of the method shown in FIG. 4A.

FIG. 4C is a flowchart depicting a second embodiment of an coherent optical equalization method of the invention.

FIG. 4D is a flowchart depicting a third embodiment of a coherent optical equalization method of the invention..

FIG. 5A is a schematic diagram depicting a first embodiment of a coherent optical equalizer of the invention.

FIG. 5B is a schematic diagram depicting a second embodiment of a coherent optical equalizer of the invention.

FIG. 6A is a schematic diagram depicting a first embodiment of a delay component that can be used in the coherent optical equalizers of FIGS. 5A, 5B and 7.

FIG. 6B is a schematic diagram depicting a second embodiment of a delay component that can be used in the coherent optical equalizers of FIGS. 5A, 5B and 7.

FIG. 7 is a schematic diagram depicting a third embodiment of a coherent optical equalizer of the invention.

FIG. 8A is a schematic diagram depicting a fourth embodiment of a coherent optical equalizer of the invention.

FIG. 8B is a schematic diagram depicting a fifth embodiment of a coherent optical equalizer of the invention.

FIG. 8C is a schematic diagram depicting a sixth embodiment of a coherent optical equalizer of the invention.

FIG. 9A is a flowchart depicting a fourth embodiment of an coherent optical equalization method of the invention.

FIG. 9B is a flowchart depicting a fifth embodiment of a coherent optical equalization method of the invention.

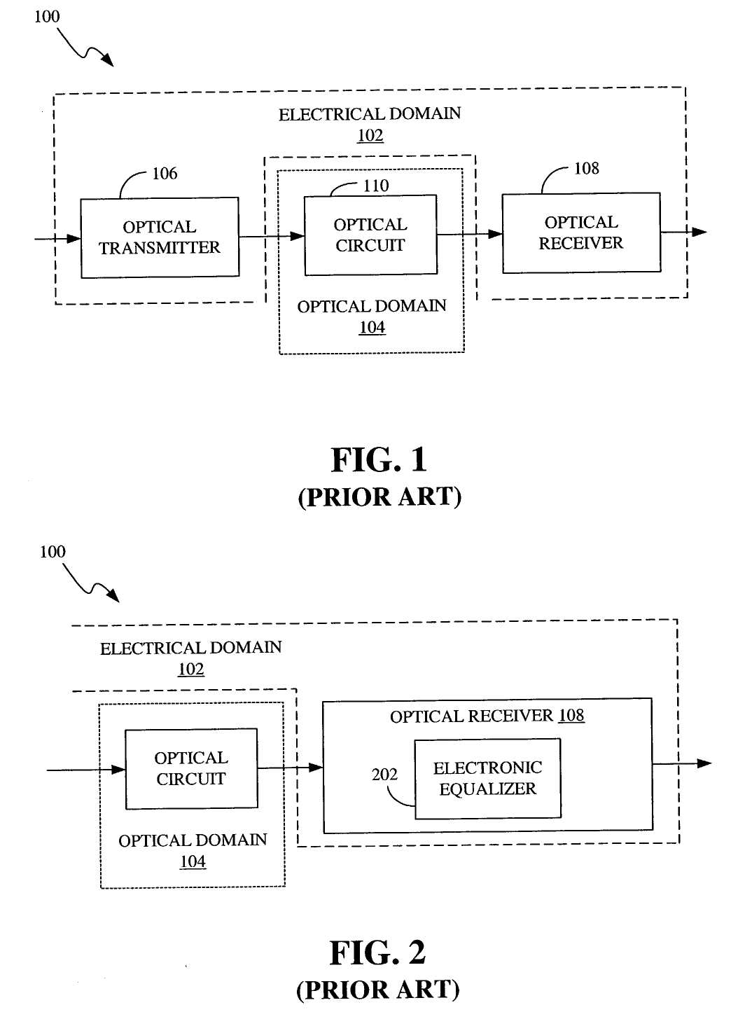

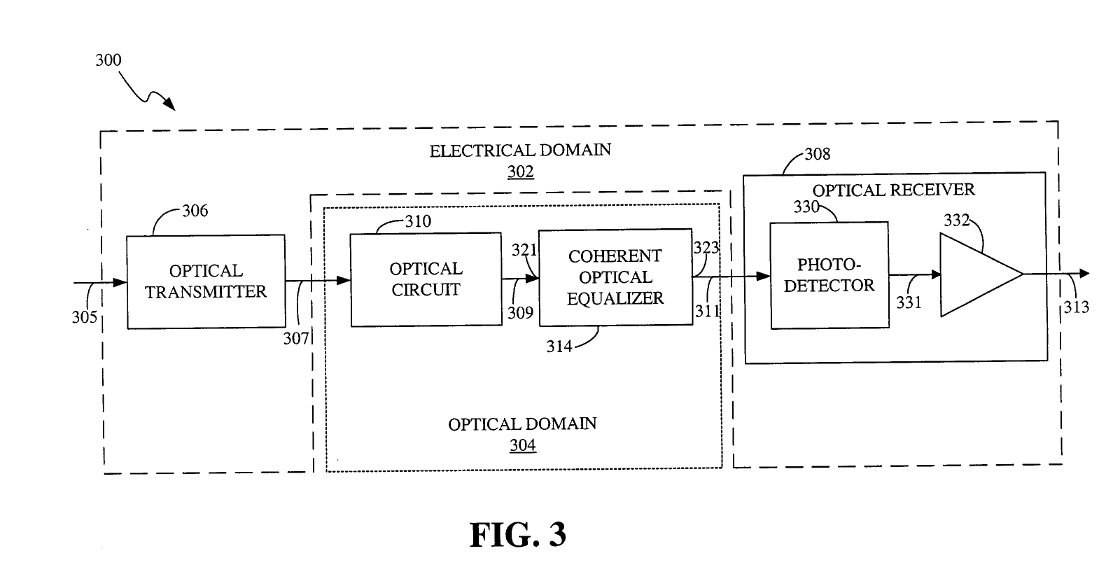

### DETAILED DESCRIPTION OF THE INVENTION

The coherent optical equalizers and coherent optical equalization methods of the invention mitigate the effects of reflections of optical signals that can occur in optical transmitters and optical circuits. This mitigation is achieved by performing coherent optical equalization on the optical signal received from an optical circuit to cancel the unwanted optical signals generated by the reflections. As will be described in greater detail below, the coherent optical equalization is performed in the optical domain, and is therefore not subject to the frequency response limitations of equalization performed in the electrical domain.

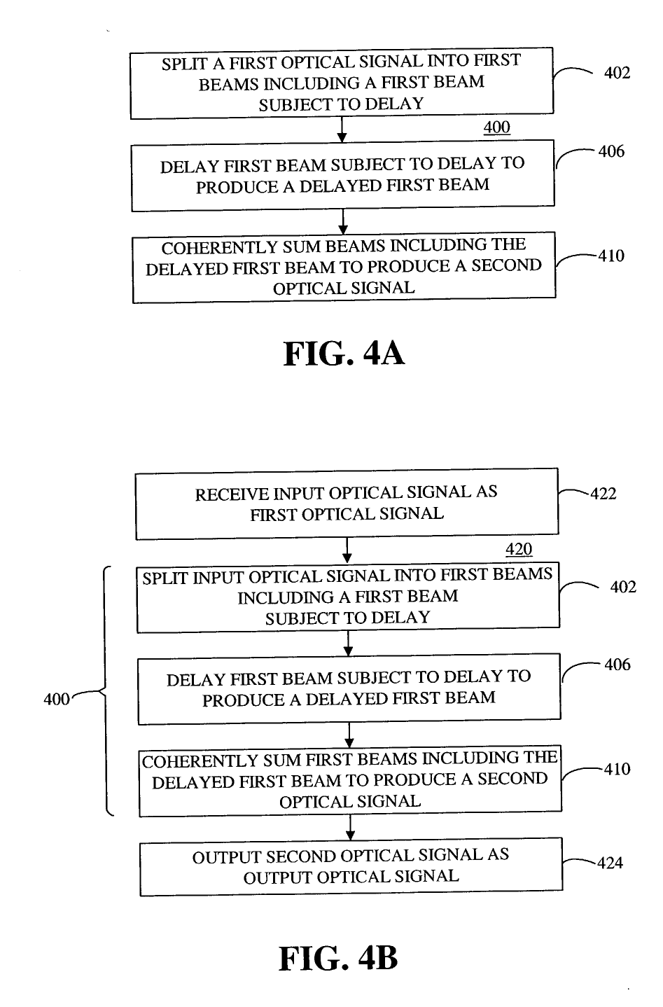

Referring to the drawings, FIG. 3 schematically depicts an optical communication system 300 incorporating a coherent optical equalizer 314 according to the invention. As shown in FIG. 3, optical communication system 300 includes an electrical domain 302 and an optical domain 304. Electrical domain 302 includes optical transmitter 306 and optical receiver 308. Optical transmitter 306 receives an electrical signal 305 that represents an information signal and, in response to the electrical signal, generates an optical signal 307 that also represents the information signal. The optical transmitter outputs optical signal 307 to optical circuit 310 located in optical domain 304.

Optical communication system 300 also includes coherent optical equalizer 314 according to the invention. The coherent optical equalizer is located in optical domain 304. Coherent optical equalizer 314 includes the optical input port 321 through which the coherent optical equalizer receives from optical circuit 310 the optical signals that constitute an input optical signal 309. The optical signals include a wanted optical signal and at least one unwanted optical signal generated in optical transmitter 306 or by passage of the wanted optical signal through the optical circuit. If left uncanceled, the unwanted optical signals would degrade the representation of the information signal by the input optical signal. Coherent optical equalizer 314 operates in the optical domain to cancel the unwanted optical signals that constitute part of input optical signal 309.

Coherent optical equalizer 314 additionally includes an optical output port 321 via which the coherent optical equalizer outputs an output optical signal 311. In the example shown, optical output port 321 is connected to the input of optical receiver 308, located in electrical domain 302. The optical receiver converts the output optical signal to an electrical signal 313 that represents information signal 305 received by optical transmitter 306.

The example of optical receiver 308 shown in FIG. 3 includes a photodetector 330 and an amplifier 332. Photodetector 330 detects output optical signal 311 received from coherent optical equalizer 314 and generates an electrical signal 331 that represents the information signal carried by the output optical signal. Amplifier 332 amplifies electrical signal 331 to generate electrical output signal 313 that also represents the information signal. Output optical signal 311 represents information signal 305 with a larger “eye” than input optical signal 309. Accordingly, output electrical signal 313 represents the information signal with a lower bit error rate than an electrical signal derived directly from the input optical signal.

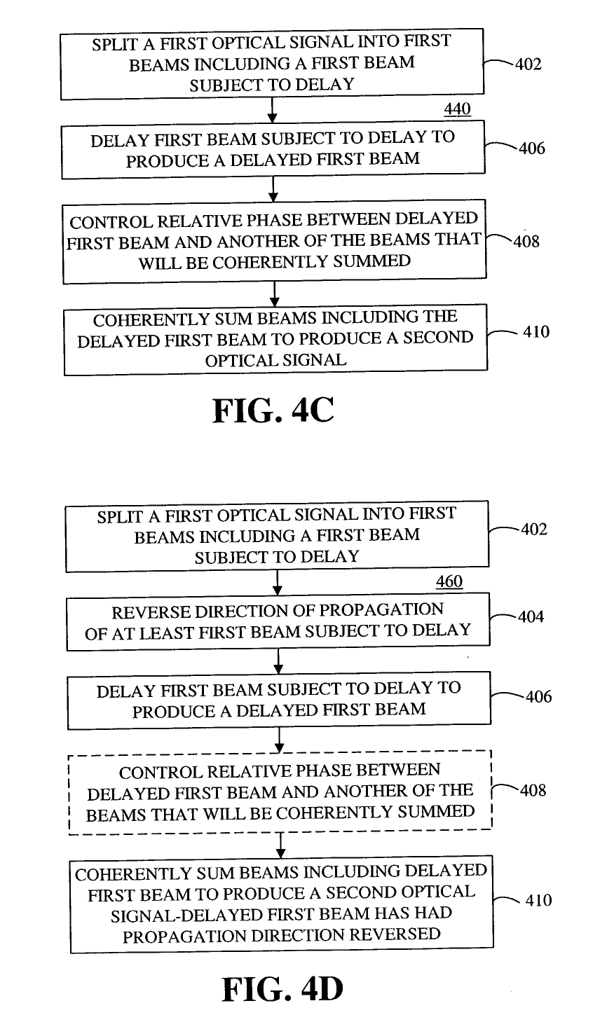

Reference will now be made to the flowchart of FIG. 4A, which depicts a first embodiment 400 of a coherent optical equalization method of the invention. The methods described in this disclosure may be performed by an embodiment of coherent optical equalizer 314, or by coherent optical equalizers different than coherent optical equalizer 314.

It should be noted that in some implementations of the methods described in the various flow charts set forth in this disclosure, the processes described in various blocks of the flowcharts may occur out of the order in which they are depicted. For example, the respective processes of two blocks shown in succession in a flowchart may, in such implementations, be performed substantially concurrently. In other implementations, the respective processes may be performed in the reverse of the order shown.

A first embodiment 400 of a coherent optical equalization method according to the invention will now be described with reference to FIG. 4A and with additional reference to FIG. 3.

In block 402, a first optical signal is split into first beams. The first beams include a first beam subject to delay. The first optical signal includes at least the wanted optical signal. Each first beam includes at least the wanted optical signal and has a fraction of the intensity of the first optical signal received in block 402. The first beams may have equal intensities, but typically differ from one another in intensity.

In block 406, the first beam subject to delay is delayed to provide a delayed first beam. Others of the first beams may also be delayed, typically by different delay times, to provide respective delayed first beams. The delay times applied to the first beams in block 406 are additionally minutely adjusted to provide the appropriate phase relationship in the coherent summing process to be described next.

In block 410, beams that include the delayed first beam are coherently summed to produce a second optical signal in which the intensity of any unwanted optical signals is substantially reduced compared with in the input optical signal.

FIG. 4B is a flow chart showing a practical example 420 of the method 400. In block 422, the input optical signal is received as the first optical signal. For example, in optical communication system 300, input signal 309 is received from optical circuit 310 as the first optical signal. The input optical signal includes a wanted optical signal representing an information signal and additionally includes n unwanted optical signals generated in the optical transmitter or by passage of the wanted optical signal through the optical circuit. The unwanted optical signals are additional instances of the wanted optical signal, delayed relative to the wanted optical signal by respective delay times.

The method 400 is then performed. In block 402, the first optical signal is divided into first beams. Thus, in this embodiment, the first optical signal and each of the first beams includes the wanted optical signal and the n unwanted optical signals. In block 406, at least the first beam subject to delay is delayed relative to one other of the first beams. In block 410, the beams coherently summed are the first beams produced in block 402, at least one of which is delayed in block 406.

In block 422, the second optical signal produced in block 410 is output as an output optical signal. For example, in optical communication system 300, the second optical signal is output as output optical signal 311.

Methods 440 and 460, to be described below with reference to FIGS. 4C and 4D, respectively, may be performed instead of method 400 in method 420.

Returning to FIG. 4A, the method 400 will now be described in greater detail. In block 402, the input optical signal as the first optical signal is split into n+1 first beams. The intensities of the first beams are set so that the intensity of the wanted optical signal in each of n of the first beams is approximately equal to the intensity of one of the unwanted optical signals in the (n+1)-th first beam. For example, an input optical signal composed of a wanted optical signal W₁ having an intensity of I₁ and two unwanted optical signals U₂ and U₃ having intensities of I₂ and I₃, respectively, is split into three first beams b₁, b₂ and b₃. In the splitting, the intensity of first beam b₂ is set such that the intensity of wanted optical signal W₁ in first beam b₂ is equal to that of unwanted optical signal U₂ in first beam b, and the intensity of first beam b₃ is set such that the intensity of wanted optical signal W₁ in first beam b₃ is equal to that of unwanted optical signal U₃ in first beam b₁. The input optical signal may alternatively be split into more than one first beam per total number of optical signals constituting the input optical signal, as will be described below.

The delay applied in block 406 to the first beam subject to delay is a gross delay corresponding to the temporal delay between the wanted optical signal and one of the unwanted optical signals in input optical signal 309. In the above example in which the input optical signal includes more than one unwanted optical signal, at least one first beam subject to delay for each unwanted optical signal is delayed in block 406. One of the first beams produced in block 402 is subject to a minimum delay and will be called a least-delayed beam. The least-delayed beam may be delayed in block 406, but is typically not subject to delay beyond its normal propagation delay.

In the above-described example of an input optical signal composed of a wanted optical signal W₁ and two unwanted optical signals U₂ and U₃ delayed relative to the wanted optical signal W₁ by delay times t₂ and t₃, respectively, the input optical signal is divided into three first beams b₁, b₂ and b₃ in block 402. In block 406, first beams b₂ and b₃ are delayed by delay times of t₂ and t₃, respectively, relative to first beam b₁, and first beam b₁ is the least-delayed beam and is not subject to delay beyond its normal propagation delay.

In the delay process performed in block 406, the delay time of the first beam subject to delay is minutely adjusted so that in the coherent summing process performed in block 410, the phase relationship between the delayed first beam and the least-delayed beam, is such that destructive interference occurs between the wanted optical signal in the delayed first beam and the unwanted optical signal in the least-delayed beam.

For example, in block 406, the delayed first beam is subject to a gross delay equal to the delay between the wanted optical signal and one of the unwanted optical signals in the input optical signal. The delayed first beam is additionally subject to a minute delay such that, at the carrier frequency of the input optical signal, it is in anti-phase with the least-delayed beam in the coherent summing process performed in block 410. With this phase relationship, destructive interference occurs in the coherent summing process that causes the delayed first beam to cancel, or at least to attenuate substantially, the corresponding unwanted optical signal in the least-delayed beam. Thus, this unwanted optical signal has a substantially reduced intensity in the second optical signal produced in block 410 compared with in the input optical signal. With an appropriate choice of the relative intensities and phases of the first beam subject to delay and the least-delayed beam, the unwanted signal may be substantially cancelled from the second optical signal.

As an alternative to the anti-phase relationship just described, the phase of the delayed first beam may be set to a value in the range of 120 to 240 degrees relative to that of the least-delayed beam. In this case, the intensity of the wanted optical signal in the delayed first beam should be greater than that of the corresponding unwanted optical signal in the least-delayed beam to enable the wanted optical signal in the delayed first beam to cancel the unwanted optical signal in the least-delayed beam. Small adjustments to the relative phase or the relative intensity between the delayed first beam and the least-delayed beam may be used to minimize the residual intensity of the unwanted optical signal.

When the input optical signal includes more than one unwanted optical signal, the least-delayed beam and delayed first beams corresponding in number to the unwanted optical signals are coherently summed in process 410. Each of the delayed first beams is grossly delayed by a delay time corresponding to the delay time of one of the unwanted optical signals in the input optical signal and is minutely delayed to provide the appropriate phase relationship with the least-delayed beam. Each delayed first beam cancels one of the unwanted optical signals from the least-delayed beam. As a result, so that the second optical signal lacks all unwanted optical signals of significant level.

FIG. 4C is a flow chart showing a second embodiment 440 of the coherent optical equalization method according to the invention. Method 440 can also be implemented by an embodiment of coherent optical equalizer 314 or by equalizers different than coherent optical equalizer 314. Elements of method 440 that correspond to elements of method 400 described above with reference to FIG. 4A are indicated using the same reference numerals and will not be described again here. Method 440 will be described with reference to FIG. 4C and with additional reference to FIG. 3.

In block 408, relative phase between the delayed first beam and another of the beams that will be coherently summed with the delayed first beam is controlled to establish a desired phase relationship in the coherent summing process performed in block 410, described above. The phases of any of the beams that will be coherently summed may be controlled in block 408.

Block 408 that forms part of method 460 allows means that the delay imposed in block 406 need not be phase coherent to define the phase relationship between the beams in the coherent summing process performed in block 410. As described above, the delay imposed on each first beam subject to delay in block 406 corresponds to the delay between the wanted optical signal and one of the unwanted optical signals in the input optical signal. The delay imposed in block 406 is a gross delay that, together with the relative phase control process performed in block 408, effectively enables the instances of the wanted optical signal in the first beams subject to delay to cancel the unwanted optical signals in the least-delayed beam when the beams are coherently summed in block 410.

To cancel the unwanted optical signals from the input optical signal, an appropriate phase relationship at the carrier frequency of the input optical signal is established between the beams coherently summed in block 410. The carrier frequency is about 200 THz in an embodiment in which the wavelength of the input optical signal is 1.5 μm. Block 408 controls the relative phase between the delayed first beam and the least-delayed beam to establish in the coherent summing performed in block 410 the phase relationship between the delayed first beam and the least-delayed beam necessary to allow the wanted optical signal in the delayed first beam to cancel the corresponding unwanted optical signal from the least-delayed beam.

As noted above, cancellation of an unwanted optical signal may be achieved by establishing an anti-phase relationship between the delayed first beam and the least- delayed beam and an intensity relationship in which the intensity of the wanted optical signal in the delayed first beam is equal to that of the corresponding unwanted optical signal in the least-delayed beam. Complete destructive interference can also be obtained between a delayed first beam and a least-delayed beam in which the wanted and unwanted optical signal differ in intensity and in which the carriers are out of phase, but are not in anti-phase. This allows the intensities of the first beams produced by the beam splitting performed in block 402 of FIG. 4C to be less-accurately defined than those of the first beams produced by the beam splitting performed in block 402 of FIG. 4A since the phase control performed in block 408 can be used to provide cancellation of the unwanted optical signals notwithstanding errors in the intensities of the first beams.

A third embodiment 460 of a coherent optical equalization method in accordance with the invention will now be described with reference to FIG. 4D and with additional reference to FIG. 3. This method can be implemented in the coherent optical equalizer 314 of FIG. 3. Elements of method 460 that correspond to methods 400 and 440 described above with reference to FIGS. 4A and 4C, respectively, are indicated using the same reference numerals and will not be described again here.

In block 404, the direction of propagation of the first beam subject to delay is reversed. For example, the direction of propagation may be reversed by reflecting the first beam subject to delay. The direction of propagation of the least-delayed beam may also be reversed.

In block 406, the first beam subject to delay is delayed to provide a delayed first beam substantially as described above with reference to block 406 of method 440. However, the delay imposed in block 406 in method 460 differs from that imposed in method 440 in that it is imposed in two stages, once before the direction of propagation reverse performed in block 404 and once after the direction of propagation reverse. One-half of the desired delay is imposed in each stage.

In block 408, the relative phase between the delayed first beam and another of the beams that will be coherently summed in block 410 is controlled substantially as described above with reference to block 408 of method 440. However, the relative phase control applied in block 408 of method 460 differs from that applied in method 440 in that it is imposed in two stages, once before the direction of propagation reverse performed in block 404 and once after the direction of propagation reverse. One-half of the desired phase control amount is imposed in each stage to provide the desired phase relationship among the beams coherently summed in block 410.

In block 410, beams including the delayed first beam are coherently summed to produce a second optical signal, substantially as described above with reference to block 410 of method 400. However, the coherent summing performed in block 410 pf method 460 differs from that applied in method 400 in that the delayed first beam that is coherently summed has had its direction of propagation reversed in block 404.

In an embodiment in which more than one of the first beams produced in block 402 is subject to delay, the directions of propagation of the first beams subject to delay are additionally reversed in block 404, the first beams subject to delay are delayed in two stages in block 406, typically by different delay times, to provide respective delayed first beams and the first beams that will be coherently summed are subject to phase control in two stages in block 408, typically by different phase control amounts, to provide the desired phase relationship among the beams coherently summed in block 410.

The delay imposed in block 406 may be phase coherent, in which case, the relative phase control block 408 may be omitted.

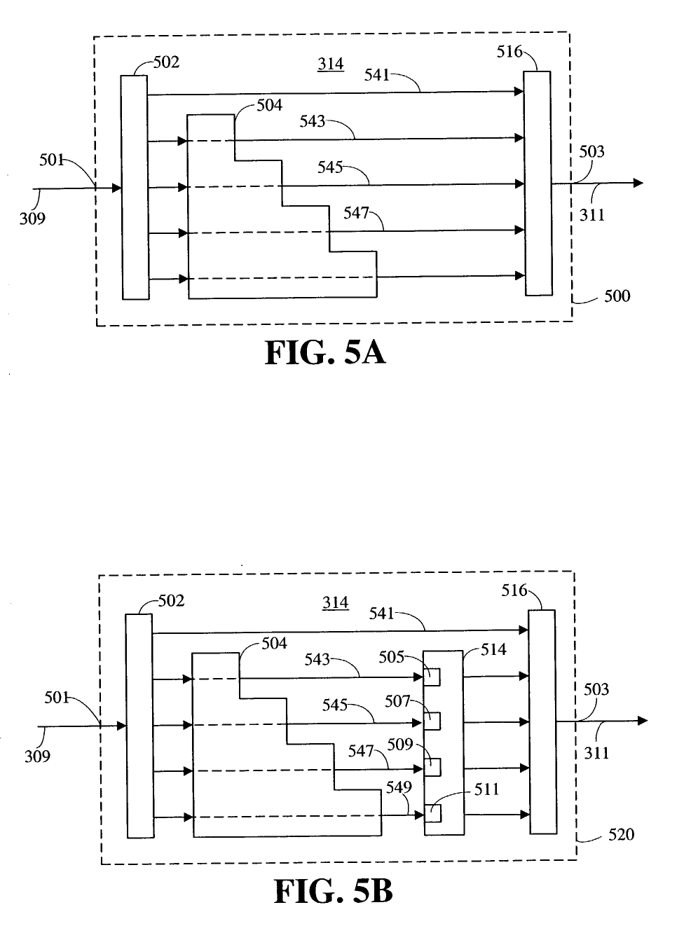

A first embodiment 500 of coherent optical equalizer 314 of the invention will now be described with reference to FIG. 5A and with additional reference to FIG. 3. Coherent optical equalizer 500 receives input optical signal 309 from optical circuit 310 as a first optical signal 501 and operates to equalize the input optical signal to generate a second optical signal 503, which is then output as output optical signal 311. The coherent optical equalizer cancels the unwanted optical signals that, together with the wanted optical signal, constitute input optical signal 309 so that the output optical signal represents only a single instance of information signal 305 received by optical transmitter 306.

Coherent optical equalizer 500 is composed of a beamsplitter 502, a delay component 504 and a coherent summing component 516. The delay component is located between the beamsplitter and the coherent summing component.

Beamsplitter 502 receives input optical signal 309 as first optical signal 501 and splits the first optical signal into first beams 541, 543, 545, 547 and 549, at least one of which is a first signal subject to delay. Beamsplitter 502 can be structured to split the input optical signal into a different number of first beams from that illustrated. Specifically, the beamsplitter is structured to divide the first optical signal into a number of first beams at least equal to the total number of optical signals, i.e., the one wanted optical signal+the number of unwanted optical signals, that constitute first optical signal 501. To cancel a single unwanted optical signal, beamsplitter 502 may split the first optical signal into only two first beams 541 and 543, with only first beam 543 being subject to delay by delay component 504. Coherent summing component 516 then sums delayed first beam 543 and least-delayed beam 541 to generate second optical signal 503 in which the unwanted optical signal is substantially reduced in intensity compared with in input optical signal 309.

Beamsplitter 502 is typically structured to split first optical signal 501 into first beams having different intensities. In an example in which the beamsplitter is structured to split the first optical signal into (n+1) first beams, the beamsplitter sets the intensities of the first beams such that the intensity of the wanted optical signal in each of n of the first beams is approximately equal to the intensity of one of the unwanted optical signals in the (n+1)-th first beam, as described above with reference to block 402 of FIG. 4A. This may result in some of the first beams having equal intensities.

Beamsplitter 502 directs first beam 541 to coherent summing component 516 and directs first beams 543, 545, 547 and 549 to delay component 504. Since first beam 516 is not subject to delay additional to its inherent propagation delay, first beam 541 is the least-delayed beam. Delay component 504 delays at least one of first beams 543, 545, 547 and 549 relative to beam 541. Each of the delays imposed by delay component 504 corresponds to the temporal delay between the wanted optical signal and one of the unwanted optical signals in input optical signal 309, as described above with reference to block 406 of FIG. 4A.

In an embodiment, delay component 504 delays the first beams 543, 545, 547 and 549 by providing optical paths having differing effective optical path lengths for these beams. For example, as shown in FIG. 5A, delay component 504 can be a step-shaped block of a transparent material having a refractive index greater than one. Delay component 504 subjects each of first beams 543, 545, 547 and 549 to a different optical path length, which delays these first beams relative to least-delayed first beam 541 by different delay times. In the example shown, delay component 504 delays first beam 543, first beam 545, first beam 547 and first beam 549 relative to first beam 541 by differing delay times.

The delay imposed on first beams 543, 545, 547 and 549 by delay component 504 is phase coherent. Thus, delay component 504 is structured not only to impose a gross delay on first beams 543, 545, 547 and 549 passing through it, it is additionally structured to delay the first beams by a delay time minutely adjusted to establish the appropriate phase relationship between least-delayed beam 541 and delayed first beams 543, 545, 547 and 549 at coherent summing component 516. This phase relationship causes destructive interference between the wanted optical signal in each delayed first beam and a respective one of the unwanted optical signals in the least-delayed beam.

Delay component 504 provides delayed first beams 543, 545, 547 and 549 to coherent summing component 516. Coherent summing component 516 additionally received least-delayed beam 541 from beamsplitter 502. Coherent summing component 516 coherently sums beams 541, 543, 545, 547 and 549 to produce second optical signal 503 and outputs the second optical signal as output optical signal 311.

In an embodiment of coherent optical equalizer 500, beamsplitter 502 comprises a diffractive optical element (“DOE”) which is employed to split input optical signal 309 into at least two first beams, e.g., first beams 541 and 543. A beamsplitter comprising a DOE uses interference and the wave properties of light to split the first optical signal. Due to the potentially different path lengths associated with a DOE, the DOE can additionally differentially delay the first beams. Thus, a single DOE can perform the function of beamsplitter 502 and all or part of the function of delay component 504. Other examples of beamsplitters known in the art include, but are not limited to, prisms, part-silvered mirrors and polarizers, each of which can be used to split first optical signal 501 into multiple first beams. A DOE or any of the other types of beamsplitter mentioned above may additionally be used as coherent summing component 516 by reversing the directions of the optical signals.

Moreover, in an embodiment of coherent optical equalizer 500, an optical component having different free-space path lengths can be used as delay component 504. However, the optical path length difference required to provide given differential delays among the first beams can be physically shortened by locating the optical paths in a medium having a higher refractive index than air. In addition, beam-folding techniques can be used to reduce the size of the delay component required to give a given delay. For example, the size of a delay component capable of producing a delay of the order of 100 ps can be reduced to under 1 cm if the optical path includes one reflective fold and is located in a typical transparent plastic material. Using such techniques, the physical size of the delay component can be reduced for the given maximum differential delay.

In an embodiment of coherent optical equalizer 500, least-delayed beam 541 additionally passes through delay component 504 and is subject to a delay. In such embodiment, the delay component delays each of first beams 543, 545, 547 and 549 relative to first beam 541 by a delay time equal to the delay between the wanted optical signal and a respective one of the unwanted optical signals in input signal 309.

A second embodiment 550 of coherent optical equalizer 314 of the invention will now be described with reference to FIG. 5B and with additional reference to FIG. 3. Elements of coherent optical equalizer 550 that correspond to elements of coherent optical equalizer 500 described above with reference to FIG. 5A are indicated using the same reference numerals and will not be described again in detail here.

Coherent optical equalizer 550 receives input optical signal 309 from optical circuit 310 as first optical signal 501 and operates to equalize the first optical signal to generate second optical signal 503, which is then output as output optical signal 311. The coherent optical equalizer cancels the unwanted optical signals that, together with the wanted optical signal, constitute input optical signal 309 so that the output optical signal represents only a single instance of information signal 305 received by optical transmitter 306.

Coherent optical equalizer 500 is composed of beamsplitter 502, delay component 504, a phase controller 514 and coherent summing component 516. The delay component and the phase controller are located between the beamsplitter and the coherent summing component. The order of the delay component and the phase controller may be the reverse of that shown.

Delay component 504 differs slightly from delay component 504 described above with reference to FIG. 5A in the delays that it imposes need not phase coherent.

Delay component 504 provides first beams 543, 545, 547 and 549 to phase controller 514, which controls the phase relationship between these beams and least-delayed beam 541. Phase controller 514 is a device having an index of refraction that can be controlled externally and individually for at least some of the first beams. For example, phase controller 514 can comprise an electro-optic material having an index of refraction that is controlled by an applied electric field for each first beam whose phase is controlled by the phase controller. In the example shown, the phase controller includes an array of liquid crystal cells (LCCs) 505, 507, 509 and 511 each located to receive one of the first beams 543, 545, 547 and 549, respectively. Each of the liquid crystal cells has an individually-controlled index of refraction. If, at the carrier frequency of input optical signal 309, e.g, 200 THz, least-delayed beam 541 and delayed first beam 543 are in phase at coherent summing component 516, but beams 541 and 543 are required to destructively interfere when coherently summed, an electric field can be applied to the liquid crystal material (not shown) of LCC 507. The electric field modifies the index of refraction of the LCC 507 such that the phase of delayed first beam 543 is shifted by 180° as the beam travels through the phase controller 514. The strength of the applied electric field applied to each LCC can be determined by the level of a control signal applied to the LCC.

As a result of the change in the phase of delayed first beam 543 imparted by LCC 507, delayed first beam 543 is in anti-phase with least-delayed beam 541 when the beams are coherently summed by coherent summing component 516. The wanted optical signal in delayed first beam 543 therefore destructively interferes with the one of the unwanted optical signals in least-delayed beam 541 to cancel this unwanted optical signal from, or substantially reduce the intensity of this unwanted optical signal in second optical signal 503. The unwanted optical signal is that having a delay time relative to the wanted optical signal equal to the delay applied to delayed first beam 543.

Examples of solid electro-optical materials suitable for use in phase controller 514 as an alternative to a liquid crystal material include lithium niobate, lithium tantalate, potassium dihydrogen phosphate, potassium dideuterium phosphate, aluminum dihydrogen phosphate, aluminum dideuterium phosphate and barium sodium niobate. Suitable alternatives to these materials are known in the art and other suitable materials may become available in the future. Examples of liquid electro-optical materials that are an alternative to a liquid crystal material include, in order of increasing electro-optical effect, benzene, carbon disulfide, water, nitrotoluene and nitrobenzene. Suitable alternatives to these materials are known in the art, and additional suitable materials may become available in the future.

Liquid crystal cells and many of the above-mentioned electro-optical materials exhibit birefringence. In embodiments in which phase controller 514 is based on a birefringent electro-optical material, beams 543, 545, 547 and 549 are separated into orthogonal polarization components prior to the polarization controller and are re-combined after the phase controller, as is known in the art.

Materials having a controllable refractive index suitable for use in phase controller 514 additionally include an electro-absorptive semiconductor material such as InGaAs to which an electric field is applied to control the bandgap of the material. The bandgap is controlled in a range in which the bandgap causes the semiconductor material to be partially absorbent at the wavelength of first optical signal 501. Another material having a controllable refractive index is a semiconductor material, such as GaAs, that is transparent at the wavelength of the input optical signal. The material is irradiated with light having a shorter wavelength than that of the input optical signal. For example, the wavelength of the irradiating light could be 780 nm and the wavelength of the input optical signal 1.5 μm. The refractive index of the semiconductor material at the wavelength of the input optical signal is controlled by controlling the intensity of the irradiating light.

Phase controller 514 directs delayed first beams 543, 545, 547 and 549 to coherent summing component 516, where the delayed first beams are coherently summed with least-delayed beam 541, as described above.

In another embodiment, least-delayed beam 541 passes through delay component 504 and is subject to a delay, and may additionally or alternatively pass through phase controller 514 and be subject to phase control. In such embodiment, the delay component delays each of first beams 543, 545, 547 and 549 relative to least-delayed beam 541 by a delay time equal to the delay between the wanted optical signal and one of the unwanted optical signals, and phase controller 514 controls the phase of one or more of first beams 541, 543, 545, 547 and 549.

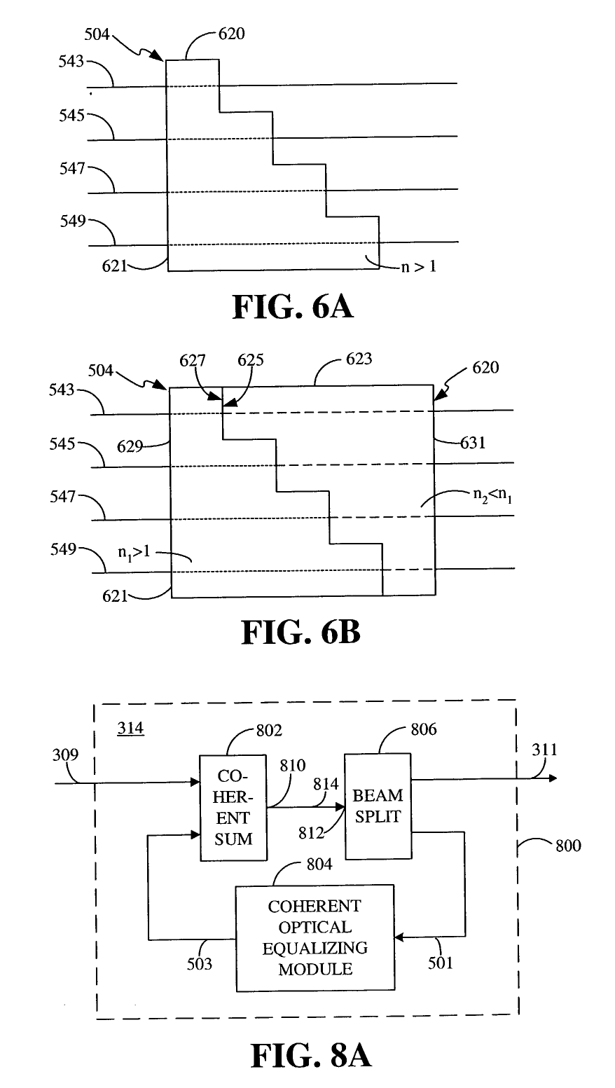

A first embodiment 600 of delay component 504 is depicted schematically in FIG. 6A. Delay component 600 includes a delay element 601 that receives first beams 543, 545, 547 and 549. As the material of delay element 601 has a refractive index n greater than one, those of the first beams having the longer optical paths through delay element 601 incur longer delays. Thus, in the example shown, first beam 549 is delayed longer than first beam 547, first beam 547 is delayed longer than first beam 545, and first beam 545 is delayed longer than first beam 543.

Delay element 601 can be structured to differentially delay more or fewer than the four first beams illustrated. As noted above, the number of first beams depends on the number of optical signals that constitute input optical signal 309. However, coherent optical equalizer 314 can be simplified by ignoring unwanted optical signals below a threshold. Additionally, in embodiments in which all the first beams are delayed, delay component 600 is structured with the same number of optical paths as the number of first beams into which the first optical signal is split, and locating the delay element so that all of the first beams pass through it. In many embodiments, the differential delays applied to the first beams are substantially less uniform than in the example shown.

A second embodiment 620 of delay component 504 is depicted in FIG. 6B. Delay component 620 includes a first delay element 621 and a second delay element 623 arranged with their stepped surfaces 625 and 627, respectively, juxtaposed. Opposite their stepped surfaces, the first delay element includes a plane surface 629 through which the first beams subject to delay are received and the second delay includes a plane surface 631 through which the delayed first beams are output. The material of each delay element has a refractive index of greater than one (1), with the material of the first delay element having a refractive index n₁ greater than the refractive index n₂ of the material of the second delay element. The delay of a particular first beam relative to another may be increased by lengthening the path length of the beam through the first delay element and/or by increasing the refractive index of the material of the first delay element.

Multiple-element embodiments of the delay component 504, such as delay component 620, may be considered mechanically advantageous. In particular, the regular external shape of such multi-element embodiments simplifies the alignment of such a delay component in an optical system compared to a delay component having an irregular external shape, such as delay component 600 depicted in FIG. 6A.

Block-type delay components such as those exemplified in FIGS. 6A and 6B conveniently produce delays in the order of a few hundred picoseconds. Such delays will deal effectively with reflections generated in or near the optical transmitter. Optical fibers of appropriate lengths can be used as delay component 504 in embodiments for use in optical communication systems in which the reflections are generated further from the optical transmitter.

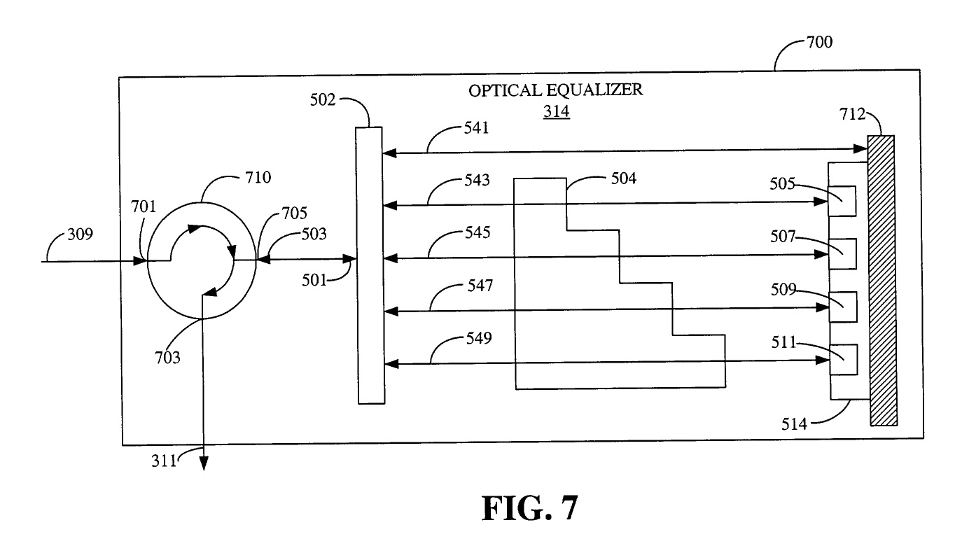

A third embodiment 700 of coherent optical equalizer 314 will now be described with reference to FIG. 7, and with additional reference to FIG. 3. Coherent optical equalizer 700 receives input optical signal 309 from optical circuit 310 as first optical signal 501 and operates to equalize the input optical signal to generate a second optical signal 503, which is then output as output optical signal 311. The coherent optical equalizer cancels the unwanted optical signals that, together with the wanted optical signal, constitute input optical signal 309 so that the output optical signal represents only a single instance of information signal 305 received by optical transmitter 306.

Coherent optical equalizer 700 is composed of an optical circulator 710, beamsplitter 502, delay component 504, phase controller 514 and a reflective component 712. The delay component and the phase controller are located between the beamsplitter and the reflective component. The order of the delay component and the phase controller may be the reverse of that shown. The phase controller may be omitted in an embodiment in which the delay produced by the delay component is phase coherent. Elements of coherent optical equalizer 700 that correspond to coherent optical equalizers 500 and 550 described below with reference to FIGS. 5A and 5B are indicated using the same reference numerals and will not be described again here.

Coherent optical equalizer 700 receives input optical signal 309 via the input port 701 of circulator 710. The circulator outputs the input optical signal as first optical signal 501 via bi-directional port 705 to beamsplitter 502. Beamsplitter 502, delay component 504 and phase controller 514 operate as described above to provide multiple, differentially-delayed first beams, including delayed first beam 543 and least-delayed beam 541, to reflective component 712. The reflective component reverses the direction of propagation of the first beams. The first beams return to the beam splitter, passing through the phase controller and the delay component a second time. The beam splitter receives the beams, including the delayed first beam, and operates in reverse to coherently sum the beams to produce second optical signal 503. Second optical signal 503 is output via the circulator as output optical signal 311.

Specifically, beamsplitter 502 splits first optical signal 501 into first beams 541, 543, 545, 547 and 549. The beamsplitter directs least-delayed beam 541 to reflective component 712 and first beams 543, 545, 547 and 549 subject to delay to delay component 504. On the first pass of first beams 543, 545, 547 and 549 subject to delay through delay component 504, the delay component delays these first beams 543, 545, 547 and 549 relative to least-delayed beam 541. Each of the delays corresponds to one-half of the temporal delay between the wanted optical signal and one of the unwanted optical signals in input optical signal 309, as described above with reference to block 406 of FIG. 4A. However, the delays need not be phase coherent. Delay component 504 provides the differentially-delayed beams to phase controller 514.

Phase controller 514 imparts one-half of the phase change on the delayed first beams 543, 545, 547 and 549 necessary to provide the desired phase relationship between least-delayed beam 541 and each of the beams when the beams are coherently summed on their return to beamsplitter 502. For example, if phase controller 514 is impart a phase shift of 90° (i.e., one-quarter of the carrier wavelength of input optical signal 309) on delayed first beam 543 relative to least-delayed beam 541, a control signal of the appropriate level can be applied to LCC 505 of the phase controller. The resulting electric field causes LCC 505 to shift the phase of first beam 543 by 900 relative to that of least-delayed beam 541.

First beams 541, 543, 545, 547 and 549 are reflected by the reflective component 712. Reflection by the reflective component reverses the direction of propagation of the first beams, and causes first beams 543, 545, 547 and 549 to propagate back through phase controller 514 and delay component 504 and causes all the first beams 541, 543, 545, 547 and 549 to propagate back through beam splitter 502. In the second pass, phase controller 514 imparts an additional shift on the phases of those first beams whose phase was shifted in the first pass through the phase controller. In the above example, the phase of delayed first beam 543 is shifted by an additional 90° on the second pass through the phase controller. After the second pass through the phase controller, the relative phase between delayed first beam 543 and least-delayed beam 541 has been shifted by a total phase shift of 180°.

The second pass through delay component 504 imparts an additional delay on each of first beams 543, 545, 547 and 549 that were delayed in the first pass. The additional delay is equal to the delay imparted on first beams 543, 545, 547 and 549 by their first pass through the delay component. Thus, each of the first beams subject to delay had been delayed by a total delay equal to the delay time between the wanted optical signal and a different one of the unwanted optical signals in the input optical signal.

On the second pass of first beams 541, 543, 545, 547 and 549 through beamsplitter 502, the beamsplitter coherently sums the beams passing in the reverse direction to produce a second optical signal 503. The second optical signal passes to bidirectional port 705 of circulator 710. In the above example, in the coherent summing performed by the beamsplitter, the wanted optical signal in delayed first beam 543 destructively interferes with the unwanted optical signal in least-delayed beam 541 due to the phase difference of 180° between the beams.

Circulator 710 is a non-reciprocal optical device that includes optical input port 701, optical output port 703 and bi-directional port 705. The bi-directional port is optically connected to beamsplitter 502. Circulator 710 receives input optical signal 309 at optical input port 701 and directs the input optical signal via bi-directional port 705 to beam splitter 502 as first optical signal 501. The circulator additionally receives second optical signal 503 from beam splitter 502 at bi-directional port 705, and directs the second optical signal to optical output port 703. The second optical signal is output from optical output port 703 as output optical signal 311. Thus, coherent optical equalizer 700 receives input optical signal 309 and outputs output optical signal 311 via circulator 710.

In the embodiments described above, the first optical signal is described as being split into at least (n+1) first beams, where n is the number of unwanted optical signals in the input optical signal. In embodiments in which at least one of the unwanted optical signals has a relatively high intensity, the first optical signal is split into more than (n+1) first beams In the case of a single high-intensity unwanted optical signal, the delayed first beam that cancels the high-intensity unwanted optical signal when the delayed first beam and the least-delayed beam are coherently summed also has a relatively high intensity. This delayed first beam includes not only a delayed version of the wanted optical signal, which cancels the high-intensity unwanted optical signal, but also delayed versions of all the unwanted optical signals, including the high-intensity unwanted optical signal. The intensity of the second instance of the high-intensity unwanted optical signal in the output optical signal, although lower than the intensity than the first instance of the high-intensity unwanted optical signal in the input optical signal, may be unacceptably high for some applications.

To overcome the problem just described, the first optical signal is split to provide an additional first beam that is delayed by a delay time twice that of the delayed first beam that cancels the first instance of the high-intensity unwanted optical signal. The intensity of the additional first beam is set so that the intensity of the wanted optical signal in the additional first beam is equal to that of the second instance of the high-intensity unwanted optical signal. The phase of the additional first beam is set to be opposite that of the second instance of the high-intensity unwanted optical signal. When coherently summed with all the other beams, the additional first beam cancels the second instance of the unwanted optical signal.

In some cases, the first optical signal may be split to produce more than one additional first beam each of which is progressively additionally delayed. The delayed additional first beams are then coherently summed with the other beams to cancel additional instances of the high-intensity unwanted optical signal. The number of additional first beams into which the first optical signal is split depends on the maximum residual intensity of the high-intensity unwanted optical signal allowed in the output optical signal. Moreover, the first optical signal may be split to provide more than one additional first beams in applications in which the input optical signal includes more than one high-intensity unwanted optical signal.

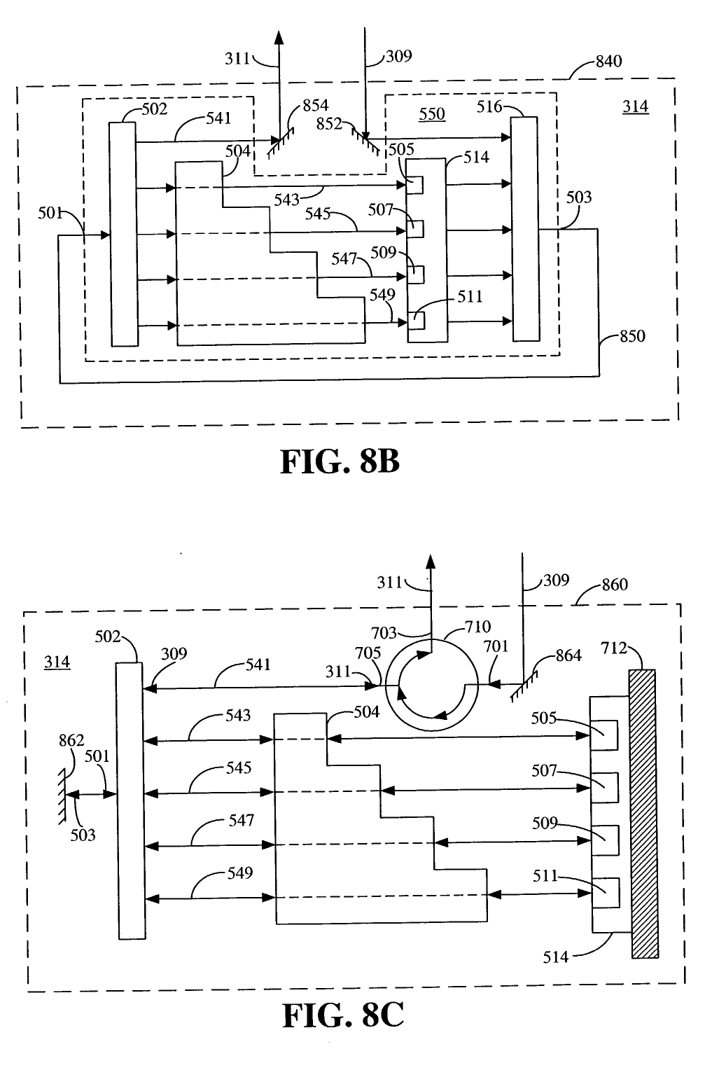

FIG. 8A shows a fourth embodiment 800 of coherent optical equalizer 314 according to the invention. Coherent optical equalizer 800 cancels high-intensity unwanted optical signals from the input optical signal without the need to split the input optical signal into more beams than the total number of unwanted optical signals in the input optical signal.

Coherent optical equalizer 800 is composed of an coherent summing component 802, a coherent optical equalizing module 804 and a beamsplitter 806. Any of coherent optical equalizers 500, 550 and 700 described above with reference to FIGS. 5A, 5B and 7, respectively, may be used as coherent optical equalizing module 804. Coherent optical equalizing module 804 receives first optical signal 501 from beamsplitter 806 and outputs second optical signal 503 to coherent summing component 802.

Referring briefly to FIG. 5B, in coherent optical equalizing module 804, beamsplitter 502 is structured to split first optical signal 501 into first beams equal in number to the number of unwanted optical signals in input optical signal 309. All of the first beams are subject to delay by delay component 504. Delay component 504 is structured to subject each of the first beams produced by the beamsplitter to a delay corresponding to the delay of a different one of the unwanted optical signals relative to the wanted optical signal in input optical signal 309.

Returning to FIG. 8A, coherent summing component 802 includes input ports and an output port 810. The input ports are optically connected to receive second optical signal 503 from coherent optical equalizing module 804 and to receive input optical signal 309, respectively.

Beamsplitter 806 includes input port 812 and two output ports. Input port 812 is optically connected to output port 810 of coherent summing component 802. Beamsplitter 806 outputs optical signal 311 via one of the output ports, and outputs first optical signal 501 to coherent optical equalizing module 804 via the other output port.

Optionally, coherent optical equalizer 800 may additionally include an optical amplifier (not shown) located between output port 810 of coherent summing component 802 and input port 812 of beamsplitter 806. The optical amplifier may alternatively be located to amplify the output optical signal 311.

Second optical signal 503 output by coherent optical equalizing module 804 is composed of instances of the wanted optical signal delayed by delays equal to the delays between the wanted optical signal and the unwanted optical signals in input optical signal 309. The instances of the wanted optical signal in the second optical signal have phases such that, when coherent summing component 802 coherently sums the second optical signal with the input optical signal, each instance cancels a corresponding one of the unwanted optical signals from the input optical signal. Thus, the coherent summing component outputs clean wanted optical signal 814. The clean wanted optical signal is composed substantially of a single instance of the wanted optical signal. Any unwanted optical signals in clean wanted optical signal 814 have intensities less than an acceptable threshold level.

Beamsplitter 806 splits clean wanted optical signal 814 into two beams, one of which the beamsplitter outputs as output optical signal 311, the other of which the beamsplitter feeds to coherent optical equalizing module 804 as first signal 501. Thus, coherent optical equalizing module 804 generates second optical signal 503 composed of instances of the wanted optical signal generated from first optical signal 501 that lacks unwanted optical signals.

The coherent optical equalizers 500, 550 and 700 described above with reference to FIGS. 5A, 5B and 7, respectively, each include a coherent summing component and a beamsplitter that may be adapted additionally to perform the functions of coherent summing component 802 and beamsplitter 806 of coherent optical equalizer 800. This allows a coherent optical equalizer that functions similarly to coherent optical equalizer 800 to be constructed without an additional coherent summing component 802 and an additional beamsplitter 806.

FIG. 8B shows a fifth embodiment 840 of a coherent optical equalizer according to the invention based on coherent optical equalizer 550 described above with reference to FIG. 5B. Elements of coherent optical equalizer 840 that correspond to elements of optical equalizers 500 and 550 described above with references to FIGS. 5A and 5B are indicated using the same reference numerals and will not be described again in detail.

Coherent optical equalizer 840 is composed of coherent optical equalizer 550, optical path 850 and reflectors 852 and 854. Coherent optical equalizer 500 described above with reference to FIG. 5A may be substituted for coherent optical equalizer 550. Optical path 850 extends from the output side of coherent summing component 516 to the input side of beamsplitter 502 to couple second optical signal 503 produced by the coherent summing component to the beamsplitter as first optical signal 501.

Reflector 852 is located to receive input optical signal 309 and is aligned to direct the input optical signal onto coherent summing component 516 as one of the beams coherently summed by the coherent summing component.

Reflector 854 is located to receive first beam 541 from beamsplitter 502 and is aligned to output first beam 541 as output optical signal 311.

Beamsplitter 502 splits first optical signal 501 into first beams equal in number to the total number of optical signals that constitute the input optical signal, i.e., the one wanted optical signal+the n unwanted optical signals.

Coherent summing component 516 receives delayed first beams 543, 545, 547 and 549 from phase controller 514 and additionally receives input optical signal 309 via reflector 852. Coherent summing component 516 coherently sums delayed first beams 543, 545, 547 and 549 and input optical signal 309 to produce second optical signal 503. The phases of the delayed first beams relative to that of input optical signal 309 are controlled by phase controller 514 such that, in the coherent summing process performed by coherent summing component 516, each of the delayed first beams cancels a respective one of the unwanted optical signals from the input optical signal. As a result, second optical signal 503 produced by coherent summing component 516 is composed substantially of a single instance of the wanted optical signal. Any unwanted optical signals in second optical signal 503 have intensities less than an acceptable threshold level.

Optical path 850 conveys second optical signal 503 to the input side of beamsplitter 502 as first optical signal 501. Beamsplitter 502 splits the first optical signal, composed of only a single instance of wanted optical signal, into multiple first beams of different intensities, as described above. Each first beam is composed of a single instance of the wanted optical signal. One of the first beams is output via reflector 854 as output optical signal 311. The remaining beams, each of which corresponds to one of the unwanted optical signals in input optical signal 309, pass to delay component 504, phase controller 514 and coherent summing component, as described above.

In a minimalist embodiment of coherent optical equalizer 840 for equalizing an input optical signal composed of a wanted optical signal and only one unwanted optical signal, beamsplitter 502 splits first optical signal 501 into only two first beams 541 and 543. First beam 541 is output as output optical signal 311. First beam 543 is delayed by delay component 504 by a delay time corresponding to the delay between the wanted optical signal and the unwanted optical signal in input optical signal 309. Phase controller 514 controls the relative phase between delayed first beam 543 and input optical signal 309 by controlling the phase of either or both of the delayed first beam and the input optical signal. Coherent summing component 516 coherently sums delayed first beam 543 and input optical signal 309 to produce second optical signal 503, which passes to the beamsplitter via optical path 850.

FIG. 8C shows a sixth embodiment 860 of a coherent optical equalizer according to the invention based on coherent optical equalizer 700 described above with reference to FIG. 7. Elements of coherent optical equalizer 860 that correspond to elements of optical equalizers 500, 550 and 700 described above with reference to FIGS. 5A, 5B and 7 are indicated using the same reference numerals and will not be described again in detail.

Coherent optical equalizer 860 is composed of a modified version of coherent optical equalizer 700 in which optical circulator 710 is re-located and reflector 862 is located at the former location of circulator 710. Coherent optical equalizer 860 is additionally composed of reflector 864.

Reflector 862 is located to receive second optical signal 503 from beamsplitter 502 operating as a coherent summing component and is aligned to direct such the second optical signal back to beamsplitter 502 along a reciprocal path as first optical signal 501. In an embodiment, reflector 862 is composed of a plane mirror mounted normal to the direction of the second optical signal output by the beamsplitter operating as a coherent summing component. Alternatively, reflector 862 may be integral with beamsplitter 502.

Optical circulator 710 is located to receive first beam 541 produced by beamsplitter 502 operating as a beamsplitter at its bi-directional port 705. Optical circulator 710 outputs first beam 541 received via bi-directional port 705 at output port 703 as output optical signal 311.

Reflector 864 is located to receive input optical signal 309 and is aligned to direct the input optical signal into input port 701 of optical circulator 710. Optical circulator direction the input optical signal via bidirectional port 705 to beamsplitter 502 operating as a coherent summing component.

Beamsplitter 502, operating as a coherent summing component, receives delayed first beams 543, 545, 547 and 549 from delay component 504 and additionally receives input optical signal 309 from bidirectional port 704 of optical circulator 710. Beamsplitter 502, operating as a coherent summing component sums delayed first beams 543, 545, 547 and 549 and input optical signal 309.The phases of the delayed first beams relative to that of input optical signal 309 are such that, in the coherent summing process performed by beamsplitter 502, the delayed beams cancel respective ones of the unwanted optical signals from the input optical signal. As a result, second optical signal 503 produced by beamsplitter 502 operating as the coherent summing component is composed substantially of a single instance of the wanted optical signal. Any unwanted optical signals in second optical signal 503 have intensities less than an acceptable threshold level.

Reflector 862 returns second optical signal 503 to beamsplitter 502 as first optical signal 501. Beamsplitter 502 operates as a beamsplitter with respect to the first optical signal received from reflector 862. The beamsplitter splits the first optical signal into a number of first beams of different intensities, as described above. Each of the first beams is composed of a single instance of the wanted optical signal. The beamsplitter directs first beam 541 to bi-directional port 705 of optical circulator 710. The circulator outputs first beam 541 via output port 703 as output optical signal 311. The remaining first beams 543, 545, 547 and 549, each of which corresponds to one of the unwanted optical signals that constitute input optical signal 309, pass to delay component 504, phase controller 514 and reflector 712, as described above.

In a minimalist embodiment of coherent optical equalizer 860 for equalizing an input optical signal of a wanted optical signal and only one unwanted optical signal, beamsplitter 502 operating as the beamsplitter splits first optical signal 501 into only two first beams 541 and 543. First beam 541 is output as output optical signal 311. First beam 543 is delayed by delay component 504 by a delay time corresponding to the delay between the wanted optical signal and the unwanted optical signal in input optical signal 309. Phase controller 514 controls the relative phase between delayed first beam 543 and input optical signal 309 by controlling the phase of either or both of the delayed first beam and the input optical signal. Reflective component reverses the direction of propagation of only delayed first beam 543. Beamsplitter 502 operating as the coherent summing component coherently sums reflected, delayed first beam 543 and input optical signal 309 to produce second optical signal 503, which is reflected back to the beamsplitter by reflector 862.

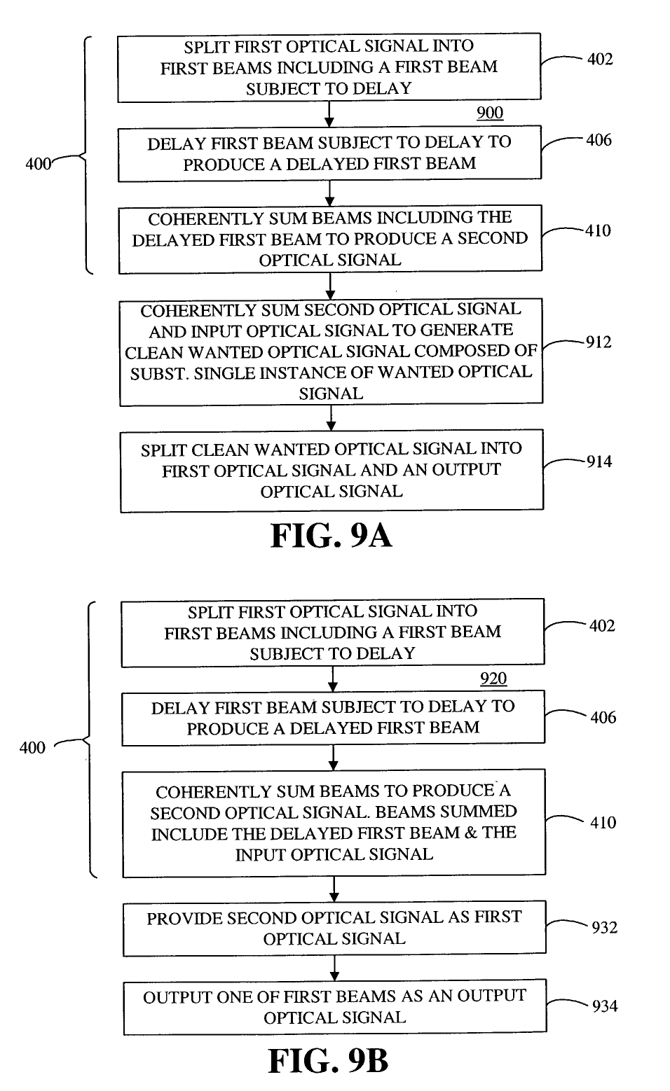

A fourth embodiment 900 of a coherent optical equalization method in accordance with the invention will now be described with reference to FIG. 9A and with additional reference to FIG. 3. This method can be implemented in the coherent optical equalizer 314 of FIG. 3, and specifically in the coherent optical equalizer 800 shown in FIG. 8A. Elements of method 900 that correspond to methods 400 and 440 described above with reference to FIGS. 4A and 4C, respectively, are indicated using the same reference numerals and will not be described again here.

Method 400 is performed to generate a second optical signal in which the unwanted optical signal has a reduced intensity compared with in the input optical signal. The second optical signal is composed of instances of the wanted optical signal delayed by delays equal to the delays between the wanted optical signal and the unwanted optical signals in the input optical signal.

In block 912, the second optical signal and the input optical signal are coherently summed. The instances of the wanted optical signal in the second optical signal have phases such that, in the coherent summing process performed in block 902, each instance cancels a corresponding one of the unwanted optical signals from the input optical signal. Thus, the coherent summing process produces a clean wanted optical signal composed of substantially a single instance of the wanted optical signal. Any unwanted optical signals in the clean wanted optical signal have intensities less than an acceptable threshold level.

In block 914, the clean wanted optical signal is split into the first optical signal and an output optical signal. The first optical signal is then subject to the beam splitting of block 402 of method 400.

Methods 440 and 460 may be substituted for method 400 in method 900.

A fifth embodiment 920 of a coherent optical equalization method in accordance with the invention will now be described with reference to FIG. 9B and with additional reference to FIG. 3. This method can be implemented in the coherent optical equalizer 314 of FIG. 3, and specifically in the coherent optical equalizer 840 shown in FIG. 8B. Elements of method 920 that correspond to methods 400 and 440 described above with reference to FIGS. 4A and 4C, respectively, are indicated using the same reference numerals and will not be described again here.

Method 400 is performed to generate a second optical signal in which the unwanted optical signal has a reduced intensity compared with in the input optical signal. In block 410 of method 400, the beams that are coherently summed include the input optical signal and the delayed first beam. As a result, the second optical signal is composed of instances of the wanted optical signal delayed by delays equal to the delays between the wanted optical signal and the unwanted optical signals in the input optical signal. In a minimalist embodiment, only the input optical signal and the delayed first beam are coherently summed.

In block 932, the second optical signal is provided to the method 400 as the first optical signal.

In block 934, one of the first beams is output as an output optical signal. The first beam output is one of the first beams other than the first beam subject to delay.

Methods 440 and 460 may be substituted for method 400 in method 920. In an embodiment in which method 460 is substituted for method 400, the second optical signal is reflected to provide the first optical signal.

The invention is used as follows. The input optical signal received from optical circuit 310 is characterized to determine the intensity and delay time of reflections in optical transmitter 306 and the optical circuit. For example, the optical transmitter may be operated to transmit light pulses into the optical circuit. The electrical signal generated by optical receiver 308 in response to the light pulses is monitored. In an ideal optical communication system devoid of reflections, the optical receiver generates a single electrical pulse in response to each transmitted light pulse. In a non-ideal optical communication system in which there are reflections in either or both of the optical transmitter and the optical circuit, the optical receiver generates a single wanted electrical pulse and at least one unwanted electrical pulse in response to each transmitted light pulse. Each unwanted electrical pulse corresponds to an unwanted optical signal. The amplitude of the wanted electrical pulse and of each unwanted electrical pulse is measured. The time delay between the wanted electrical pulse and each unwanted electrical pulse is also measured.

The characterization data are then used to determine the coherent optical equalization required to cancel or reduce the unwanted optical signals resulting from reflections. The number of unwanted electrical pulses, each corresponding to an unwanted optical signal, determines the number of beams into which the input optical signal is split. In some embodiments of the coherent optical equalizer, additional beams may be required in applications in which the intensity of one or more of the unwanted electrical pulses is relatively high, as described above. On the other hand, unwanted electrical pulses having an amplitude less than a threshold amplitude can be ignored, and no beam corresponding to such pulses need be provided. The threshold amplitude depends on the target maximum bit error rate. A lower target maximum bit error rate requires a lower threshold amplitude.

The amplitudes of the unwanted electrical pulses represent the intensities of the unwanted optical signals. The intensities of the beams into which the input optical signal is split are determined by the amplitudes of the unwanted electrical pulses relative to the amplitude of the wanted electrical pulse, in a manner similar to that described above, particularly with reference to block 402 of FIG. 4A. The beam intensities are determined from the measured amplitudes of the electrical pulses. The beam splitting processes 402, 414 and 704 are performed in response to the determined beam intensities. Beamsplitter 502 is designed using the determined beam intensities.

The time delays between the wanted electrical pulse and each of the unwanted electrical pulses represent the time delays between the wanted optical signal and each of the unwanted optical signals. The delay processes of blocks 406 and 416 are performed so that each delayed beam is delayed by a delay time corresponding to the delay time between the wanted optical signal and the unwanted optical signal having an intensity equal to that of the wanted optical signal in the beam. The delay processes of blocks 706 and 714 are performed so that each delayed beam is delayed by a delay time corresponding to one half of the delay time between the wanted optical signal and the unwanted optical signal having an intensity equal to that of the wanted optical signal in the beam. Delay component 504 of coherent optical equalizer 500 is structured so that each beam is delayed by a delay time corresponding to the delay time between the wanted optical signal and the unwanted optical signal having an intensity equal to that of the wanted optical signal in the beam. Delay component of coherent optical equalizer 700 is structured so that each beam is delayed by a delay time corresponding to one half of the delay time between the wanted optical signal and the unwanted optical signal having an intensity equal to that of the wanted optical signal in the beam.

It should be emphasized that the above-described embodiments of the invention are examples set forth to help provide a clear understanding of the invention. Many variations and modifications may be made to the above-described embodiments of the invention without departing substantially from the invention defined by the following claims.

We claim:

1. A coherent optical equalizer for an input optical signal, the input optical signal including a wanted optical signal and an unwanted optical signal temporally delayed relative to the wanted optical signal, the equalizer comprising:
a beamsplitter configured to split a first optical signal including at least the wanted optical signal into first beams including a first beam subject to delay;
a delay component arranged to receive at least the first beam subject to delay from the beamsplitter and configured to delay the first beam subject to delay to provide a delayed first beam; and
a coherent summing component located to receive beams including the delayed first beam, at least one of the beams including the wanted optical signal, the coherent summing component structured to coherently sum the beams to generate a second optical signal in which the unwanted optical signal has a reduced intensity compared with in the input optical signal.

2. The equalizer of claim 1, in which:
the second beams correspond to the first beams; and
the input optical signal is received as the first optical signal and the second optical signal is output as an output optical signal.

3. The equalizer of claim 2, in which:
in the input optical signal, the unwanted optical signal is temporally delayed relative to the wanted optical signal by a first delay time; and
the delay component is configured to delay the first beam subject to delay relative to a least-delayed one of the beams received by the coherent summing component by the delay time substantially equal to the first delay time.

4. The equalizer of claim 1, in which:
in the input optical signal, the unwanted optical signal is temporally delayed relative to the wanted optical signal by a first delay time; and
the delay component is configured to delay the first beam subject to delay relative to the wanted optical signal in one of the beams received by the coherent summing component by a delay time substantially equal to the first delay time.

5. The equalizer of claim 1, additionally comprising a phase controller located between the beamsplitter and the coherent summing component and structured to control relative phase between the delayed first beam and at least one other of the beams received by the coherent summing component in response to a control signal.

6. The equalizer of claim 5, in which the phase controller comprises a material having an index of refraction controllable by the control signal.

7. The equalizer of claim 5, in which the phase controller comprises an electro-optic material having an index of refraction controllable by an electrical control signal.

8. The equalizer of claim 5, in which the phase controller comprises a semiconductor material having an index of refraction controllable by an optical control signal.

9. The equalizer of claim 5, in which the phase controller comprises a semiconductor material having a band gap and an index of refraction controllable by an electrical control signal changing the band gap

10. The equalizer of claim 1, in which:
the beamsplitter is a first beamsplitter;
the coherent summing component is a first coherent summing component; and
the equalizer additionally comprises:
a second coherent summing component arranged to receive the second optical signal from the first coherent summing component and additionally to receive the input optical signal, and structured to coherently sum the second optical signal and the input optical signal to generate an optical signal composed substantially of a single instance of the wanted optical signal, and
a second beam splitter optically connected to receive the optical signal from the second coherent summing component and structured to split the optical signal into the first optical signal for delivery to the first beam splitter and additionally into an output optical signal.

11. The equalizer of claim 10, additionally comprising a phase controller located between the first beamsplitter and the first coherent summing component and structured to control relative phase between the delayed first beam and at least one other of the beams received by the second coherent summing component in response to a control signal.

12. The equalizer of claim 1, in which:
the coherent summing component receives the input optical signal as one of the beams;
the equalizer additionally comprises an optical path extending between the coherent summing component and the beamsplitter to feed the second optical signal to the beamsplitter as the first optical signal; and
one of the first beams, other than the first beam subject to delay, is output as an output optical signal.

13. The equalizer of claim 12, additionally comprising a phase controller located between the beamsplitter and the coherent summing component and structured to control relative phase between the delayed first beam and at least one other of the beams received by the coherent summing component in response to a control signal.

14. The equalizer of claim 1, in which:
the equalizer additionally comprises a reflective component arranged to receive the first beams, including the delayed first beam, and configured to reverse a direction of propagation thereof;
the beamsplitter is integral with the coherent summing component, receives the beams, including the reflected delayed first beam, and coherently sums the beams to generate the second optical signal; and
the equalizer additionally comprises a circulator configured to receive the first optical signal and to direct the first optical signal to the beamsplitter, and additionally to receive the second optical signal from the beamsplitter and to output the second optical signal.

15. The equalizer of claim 14, in which the circulator receives the input optical signal as the first optical signal and outputs the second optical signal as an output optical signal.

16. The equalizer of claim 14, additionally comprising a phase controller located between the beamsplitter and the reflective component and structured to control relative phase between the delayed first beam and at least one other of the beams received by the beamsplitter in response to a control signal.

17. The equalizer of claim 14, in which:
the unwanted optical signal is temporally delayed relative to the wanted optical signal by a first delay time;
the reflective component is arranged to reflect the delayed first beam back to the delay component; and
the delay component additionally delays the delayed first beam so that the total delay time imposed on the delayed first beam by the delay component is substantially equal to the first delay time.

18. The equalizer of claim 14, in which:
the beamsplitter is a first beamsplitter and the coherent summing component integral with the beamsplitter is a first coherent summing component; and
the equalizer additionally comprises:
a second coherent summing component arranged to receive the second optical signal from the circulator and additionally to receive the input optical signal, and structured to coherently sum the second optical signal and the input optical signal to generate an optical signal composed substantially of a single instance of the wanted optical signal, and
a second beam splitter optically connected to receive the optical signal from the second coherent summing component and structured to split the optical signal into the first optical signal for delivery to the circulator and additionally into an output optical signal.

19. The equalizer of claim 18, additionally comprising a phase controller located between the beamsplitter and the reflective component and structured to control relative phase between the delayed first beam and at least one other of the beams received by the beamsplitter in response to a control signal.

20. The equalizer of claim 14, in which:
the reflective component is a first reflective component;
the circulator is located between the beamsplitter and the first reflective component and is configured to receive the input optical signal instead of the first optical signal and to direct the input optical signal to the beamsplitter and is additionally configured to receive one of the first beams other than the delayed first beam from the beamsplitter and to output the one of the first beams as an output optical signal;
the beamsplitter operating as the coherent summing component is located to receive the input optical signal from the circulator as one of the beams that are coherently summed to generate the second optical signal;
the equalizer additionally comprises a second reflective component arranged to receive the second optical signal from the beamsplitter and to reflect the second optical signal back to the beamsplitter as the first optical signal; and
the beamsplitter, operating as the beamsplitter, is arranged to direct the one of the first beams, other than the first beam subject to delay, to the circulator.

21. The equalizer of claim 20, additionally comprising a phase controller located between the beamsplitter and the reflective component and structured to control relative phase between the delayed first beam and at least one other of the beams received by the beamsplitter in response to a control signal.

22. A method for performing coherent equalization of an input optical signal, the input optical signal including a wanted optical signal and an unwanted optical signal temporally delayed relative to the wanted optical signal, the method comprising:
splitting a first optical signal including at least the wanted optical signal into first beams, the first beams including a first beam subject to delay;
delaying the first beam subject to delay to provide a delayed first beam; and
coherently summing beams including the delayed first beam to generate a second optical signal in which the unwanted optical signal has a reduced intensity compared with in the input optical signal.

23. The method of claim 22, in which, in coherently summing the beams, the first beams are coherently summed.

24. The method of claim 22, in which:
in the input optical signal, the unwanted optical signal is temporally delayed relative to the wanted optical signal by a first delay time;
at least one of the beams that are coherently summed includes the wanted optical signal; and
delaying the first beam subject to delay includes delaying the first beam subject to delay relative to the wanted optical signal in one of the beams that are coherently summed by a delay time substantially equal to the first delay time.

25. The method of claim 22, additionally comprising controlling relative phase between the delayed first beam and at least one other of the beams that are coherently summed to provide a desired phase relationship in the coherently summing.

26. The method of claim 22, in which
the method additionally comprises reversing the direction of propagation of at least the first beam subject to delay; and
in the coherently summing, the beams include the delayed first beam that has had its direction of propagation reversed.

27. The method of claim 26, additionally comprising controlling relative phase between the delayed first beam and at least one other of the beams that are coherently summed to provide a desired phase relationship in the coherently summing.

28. The method of claim 22, additionally comprising:
receiving the input optical signal as the first optical signal; and
outputting the second optical signal as an output optical signal.

29. The method of claim 22, additionally comprising:
coherently summing the second optical signal and the input optical signal to generate a clean wanted optical signal composed substantially of a single instance of the wanted optical signal, and
splitting the clean wanted optical signal into the first optical signal and an output optical signal.

30. The method of claim 22, in which:
in coherently summing the beams, including the delayed first beam, the beams that are coherently summed include the input optical signal; and
the method additionally comprises:
providing the second optical signal as the first optical signal, and
outputting one of the first beams, other than the first beam subject to delay, as an output optical signal.

31. The method of claim 30, in which providing the second optical signal as the first optical signal includes reflecting the second optical signal to provide the first optical signal.

32. The method of claim 22, in which:
in the input optical signal, the unwanted optical signal is temporally delayed relative to the wanted optical signal by a first delay time; and
the method additionally comprises delaying another of the first beams by a delay time substantially equal to twice the first delay time

33. The method of claim 22, in which splitting the first optical signal includes setting the intensity of the first beam subject to delay such that, in the coherent summing, the intensity of the wanted optical signal in the delayed first beam is substantially equal to the intensity of the unwanted optical signal in another of the beams that are coherently summed.
